(19) United States
(12) Patent Application Publication
(10) Pub. No.: US 2005/0036903 A1
(43) Pub. Date: Feb. 17, 2005

(54) Pewitt analyzer

(76) Inventor: Patrick Colclasure, St. Charles, MO (US)

Correspondence Address: Henry W. Cummings, 3313 W. Adams St., St. Charles, MO, 63301, US

(21) Appl. No.: 10/606,020

(22) Filed: Jun. 26, 2003

(51) Int. Cl. G05B 1/00; G01N 31/00

(52) U.S. Cl. 422/14; 422/3; 422/68.1; 210/739; 436/6; 700/266; 700/267

(57) ABSTRACT

This invention relates to an analyzer for measuring and monitoring the behavior of the naturally occurring calcium ion within a cooling tower's makeup water and recirculating water, adjusting a cooling water scale and corrosion inhibitor treatment dosing to manipulate the behavior of the naturally occurring calcium ion, within the cooling tower water, to prevent scaling and corrosion within a cooling tower system.

### I FIELD OF THE INVENTION

This invention relates to an analyzer for measuring and monitoring the behavior of the naturally occurring calcium ion within a cooling tower's makeup water and recirculating water, adjusting a cooling water scale and corrosion inhibitor treatment dosing to manipulate the behavior of the naturally occurring calcium ion, within the cooling tower water, to prevent scaling and corrosion within a cooling tower system.

### II BACKGROUND OF THE INVENTION

Cooling tower water is used to remove heat from processes. During this cooling process, the cooling water will have scaling or corrosion potentials. Chemical scale and corrosion inhibitors, commonly in parallel with a polymeric dispersant, are utilized to control the scaling or corrosion potentials for any given body of cooling water. Typically, the targeted treatment concentrations, within a cooling tower water, are control and monitored via a manual treatment test (e.g. molybdate, organophosphonate, polymer tracers, etc.) and/or an on-line monitoring analyzer, utilizing some type of a tracer (e.g. fluorescent tracer, etc). These methods of monitoring treatment or tracer levels are common and allow the end-user a means of some sense of control of the treatment/tracer levels. These methods are common, but do not allow the end-user the ability to determine exactly how much scale and corrosion inhibitor is actually needed, based upon the continuous changes in the makeup and cooling tower water characteristics (e.g. calcium ion, alkalinity, chlorides, pH, conductivity, total dissolved solids, etc.) and the applied variables (e.g. temperature, evaporation rates, bleed off rates, scale and corrosion inhibitor levels, etc) during the course of a day of the cooling water process operation. Just the treatment or tracer levels are actually being monitored.

From this deficiency in currently available testing and monitoring technology, the development of this analyzer, for the periodic and/or continuous measuring and monitoring of the naturally occurring calcium ion within a cooling tower's makeup water and recirculating water, and the influence upon the calcium ion, in the presence of the scale and corrosion inhibitor, was developed.

An important feature of this invention is the naturally occurring calcium ion within the cooling tower's makeup water and the behavior of the naturally occurring calcium ion within the recirculating cooling tower water.

There are several existing patents that pertain to the water treatment industry, but no existing patents were found to utilize this unique analyzer. U.S. Pat. No. 6,068,012 disclosed a method of monitoring at least one performance parameter relating to conditions within an aqueous system. This disclosed method mechanically measures flow rates, corrosion rates, fouling factors, oxidation-reduction potentials (ORP) and pH, makes a sequenced comparison of each of these variables and responds accordingly. Then PEWTT Analyzer differs in that the behavior of only one naturally occurring water characteristic within the makeup and cooling tower water tower, calcium ion is being measured and observed. The behavioral characteristics of the calcium ion within the cooling tower water determines the proper analyzer response.

U.S. Pat. No. 5,360,549 discloses a method of utilizing the mechanical measurement of heat transferrates to determine the solubility or insolubility of calcium-carbonate, CaCO3.

In the PEWTT Analyzer the actual concentration of the calcium ion within the makeup water and the cooling tower water is being measured and observed. The behavioral characteristics of the calcium ion, an increase or decrease, within the cooling tower water, determines the proper analyzer response.

U.S. Pat. No. 5,435,969 disclosed a method of adding an incipient to a water treatment agent, utilizing a fluorescence analysis of a water sample and establishing an in-system concentration of the water treatment agent. PEWTT Analyzer differs in that only one naturally occurring water characteristic within the makeup water and cooling tower water, calcium ion, is being measured and observed. The behavioral characteristics of the calcium ion within the cooling tower water determines the proper analyzer response.

U.S. Pat. No. 5,171,450 discloses a method of allowing a treating agent to bear an amine-containing fluorescent moiety tag covalently bonded thereto, allowing sample analysis for emissivity as a measure of concentration equitable to the performance of treating agent in the systems. The PEWTT Analyzer differs in that only one naturally occurring water characteristic within the makeup water and the cooling tower water, calcium ion, is being measured and observed. The behavioral characteristics of the calcium ion within the cooling tower water determines the proper analyzer response. Consideration of any tracer/incipient is not a significant feature in the performance of the PEWTT Analyzer.

U.S. Pat. No. 6,315,909 B1 discloses a method of controlling a cooling water system in which control is based upon a fluoresce tracer and various treatment rating system, which is used within a control Matrix. The PEWTT Analyzer differs in that naturally occurring water characteristic within the makeup water and cooling tower water, calcium ion, is being measured and observed. The behavioral characteristics of the calcium ion within the cooling tower water determines the proper analyzer response. Consideration of any tracer/incipient or treatment level is not a significant feature of the PEWTT Analyzer.

U.S. Pat. No. 4,783,314 discloses a method to determine performance of a treating agent by employing an inert fluorescent tracer: treating agent proportion ratio. The PEWTT Analyzer differs in that one naturally occurring water characteristic within the makeup water and cooling tower water, calcium ion, is being measured and observed. The behavioral characteristics of the calcium ion within the cooling tower water determines the proper analyzer response. Consideration of any tracer/incipient or treatment level is not a significant feature in the performance of the PEWTT Analyzer.

U.S. Pat. No. 5,435,969 disclosed a method of adding an incipient to a water treatment agent, utilizing a fluorescence analysis of a water sample and establishing an in-system concentration of the water treatment agent. The PEWTT Analyzer differs in that one naturally occurring water characteristic within the makeup water and cooling tower water, calcium ion, is being measured and observed. The behavioral characteristics of the calcium ion within the cooling tower water determines the proper analyzer response.

Consideration of any tracer/incipient is not a significant feature of the performance of the PEWTT Analyzer.

U.S. Pat. No. 5,278,074 discloses a method of measuring an aromatic azole corrosion inhibitor in the water of an aqueous system is monitored by a fluorometric method.

The PEWTT Analyzer differs in that one naturally occurring water characteristic within the makeup water and cooling tower water, calcium ion, is being measured and observed.

The behavioral characteristics of the calcium ion within the cooling tower water determines the proper analyzer response. Consideration of any tracer/incipient or treatment level is not a significant feature of the performance of the PEWTT Analyzer.

U.S. Pat. No. 4,992,380 discloses a method of continually monitoring by real-time analysis of a spectral or chemical characteristics of an inert tracer proportional to the treating agent.

This characteristic is indicative of tracer concentration, and converted to a voltage analog.

The PEWTT Analyzer differs in that one naturally occurring water characteristic within the makeup water and cooling tower water, the calcium ion, is being measured and observed. The behavioral characteristics of the calcium ion within the cooling tower water determines the proper analyzer response. Consideration of any tracer/incipient or treatment level is not a significant feature of the performance of the PEWTT Analyzer.

U.S. Pat. No. 4,966,711 discloses a method of utilizing transitions metals as tracers in aqueous liquid systems. The PEWTT Analyzer differs in that one naturally occurring water characteristic within the makeup water and cooling tower water, calcium ion, is being measured and observed.

### III SUMMARY OF THE INVENTION

The PEWTT Analyzer determines the naturally occurring calcium ion and chloride/conductivity concentration within a cooling tower's makeup water, determines the calcium ion and chloride/conductivity within the cooling tower's recirculating water, calculates the minimum targeted calcium ion within the cooling tower recirculating water (based upon the concentration of the naturally occurring calcium ion and chloride/conductivity within the makeup water and recirculating water) and calculates the percentage of calcium ion concentration under or over the calculated targeted calcium ion within the cooling tower water. If the actual calcium ion within the cooling tower recirculating water is below the calculated minimum calcium ion, then scaling tendencies have been identified. Should the actual calcium ion within the cooling tower water be 1OO-150% of the calculated minimum calcium ion, then a positive tendency is occurring.

Should the actual calcium ion within the cooling tower water be above 150% of the minimum calcium ion, then calcium ion is being scavenged from the cooling tower system, resulting in a hyperactive tendency. Based upon monitoring the behavior of the calcium ion within the cooling tower water, a cooling water scale and corrosion treatment can be administered efficiently within a cooling tower water to maintain the calcium ion at or slightly above (100-150%) the calculated minimum calcium ion. By maintaining the administration of the cooling water scale and corrosion treatment, based upon the behavior of the calcium hardness, the PEWTT Analyzer allows an efficient application of the treatment.

Makeup and cooling tower water has a determined behavior, dependent upon the naturally occurrin water characterists (calcium ion, chlorides, alkalinity pH, conductivity, total dissolved solids, etc.). The PEWTT Analyzer maintains effecient application of scale and corrosion inhibitors by measuring and monitoring the behavior of the targeted naturally occurring calcium ion and chloride ion/conductivity within the cooling tower's makeup and recirculating water. Based upon the naturally occurring makeup and cooling tower water characteristics and the applied variables, measuring the behavior of a targeted naturally occurring calcium ion within the makeup and cooling tower water, will allow a scale and corrosion inhibitor dosing rate to be accurately determined for existing water characteristics and the applied variables.

### IV THE DRAWINGS

FIG. 1 is a schematic flow chart of the PEWTT ANALYZER.

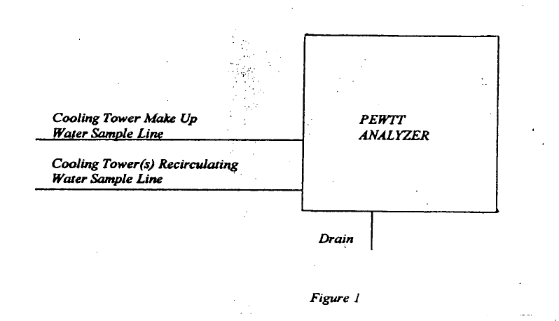

### V DESCRIPTION OF PREFFERRED EMBODIMENTS

Makeup water to a cooling tower system has site-specific calcium ion and chloride ion/conductivity characteristics. Within the cooling tower water, the calcium ion behavior characteristics, in relationship to the existing water characteristics (e.g., chlorides, alkalinity, pH, total dissolved solids, conductivity, etc.) and applied variables (e.g. temperature, evaporation rates, bleed-off rates, etc.), can be measured within the cooling water.

The Basic Unit is equipped with a microprocessor/PLC, internal 1/0 and hardware that will control and perform the tests on a cooling tower's makeup water and tower water respectively. The analyzer will first perform a series of test on the make up water. Then a second series of tests will be performed on the recirculating water. A “flush and rinse” cycle will be performed between each series of tests to ensure the equipment is processing valid water samples. After all the tests are completed, the microprocessor/PLC will perform the pertinent calculations to assess the behavior of the calcium ion within the cooling tower's recirculating water, at the time of each testing. Based on the assessment results, the PEWTT analyzer will regulate and adjust chemical addition and bleed off requirements to maintain optimum efficient application of a scale and corrosion inhibitor treatment.

The Basic Unit is equipped with a microprocessor/PLC, internal 1/0 and hardware such as Horney mini ocs that will control and perform the tests on a cooling tower's makeup water and tower water respectively.

The analyzer will first perform a series of test on the make up water. Then a second series of tests will be performed on the recirculating water. A “flush and rinse” cycle will be performed between each series of tests to ensure the equipment is processing valid water samples. After all the tests are completed, the microprocessor/PLC will perform the pertinent calculations to assess the behavior of the calcium ion within the cooling tower's recirculating water, at the time of each testing. Based on the assessment results, the PEWTT analyzer will regulate and adjust chemical addition and bleed off requirements to maintain optimum efficient application of a scale and corrosion inhibitor treatment.

### EXAMPLE I

For example, a makeup water source has 100 ppm calcium ions and 30 ppm chloride ions/300 uS conductivity; is added to a cooling tower system to makeup the water being evaporated from a cooling tower. Due to evaporation of a percentage of the water within the cooling tower system, the calcium ion and chloride ions/conductivity are accumulated (cycles of concentration) within the cooling tower water. If the tower water, for example, should contain 350 ppm calcium ions and 150 ppm chloride ions/1,500 uS conductivity, then the PEWTT Analyzer measures and and calculates the cooling tower water to have 5.00 cycles of concentration, based upon the naturally occurring chloride ion (150 ppm chloride ion towerwate/30 ppm chloride ion makeup water=5.00 cycles of concentration chloride or conductivity (1500 uS conductivity tower water/300 uS conductivity makeup water=5.00 cycles of concentration conductivity). Understanding 5.00 cycles of concentration exist within the cooling tower water, at the time of this testing, the theoretical concentration of the minimum calcium ion within the cooling tower water is calculated to be 500 ppm (5.00 cycles of concentration×1OO ppm calcium ions makeup water=500 ppm calcium ions towerwate). PEWTT Analyzer measures and compares the actual calcium ions within the cooling tower water to the calculated theoretical minimum calcium ions within the cooling tower water, then detennines the behavior of the calcium ion cooling tower water to be one of the following three:
1. Precipitating Behavior (calcium ions tower water less than 100% of calcium ions theoretical min)
2. Positive Behavior (calcium ions tower water 100%-150% of calcium ions theoretical min.)
3. Hyperactive Behavior (calcium ions tower water greater than 150% of calcium ions theoretical min.)

Based on the given example, the calcium ion within the cooling tower water displays a Precipitating Behavior (350 ppm calcium ions to˜water/500 ppm calcium ions theoretical min.=70% of the calcium ions theoretical min. (precipitating Behavior=calcium ions tower water less than 100% of calcium ions theoretical min).

With the addition of a scale and corrosion inhibitor, and the makeup water source containing, in this example, 1OO ppm calcium ions and 30 ppm chloride ions/300 uS conductivity, the cooling tower water containing 575 ppm calcium ions and 150 ppm chloride ions/b 1500 uS conductivity, Positive Behavior is demonstrated.

### EXAMPLE II

This is illustrated in the following example; the tower water contains 150 ppm chloride ions/300 uS conductivity, so the cooling tower water is calculated to have 5.00 cycles of concentration, based upon the naturally occurring chloride ion (150 ppm chloride ion tower water 30 ppm chloride ion makeup water=5.00 cycles of concentration) or conductivity (1500 uS conductivity tower water/300 uS conductivity makeup water=5.00 cycles of concentration conductivity).

Understanding that 5.00 cycles of concentration exist within the cooling tower water, at the time of this testing, the theoretical minimum concentration of the calcium ion within the cooling tower water is calculated to be 500 ppm (5.00 cycles of concentration×100 ppm calcium ions makeup water=500 ppm calcium ions theoretical min).

The PEWTT analyzer measures 575 ppm calcium within the tower water. Based on this data, the calcium ion within the cooling tower water displays a Positive Behavior (575 ppm calcium ions tower water/500 ppm calcium ions theoretical min).=115% of the calcium ions theoretical min. (Positive Behavior=calcium ions tower water 100%-150% of calcium ions theoretical min).

Hyperactive Behavior of the calcium ion tower water is illustrated, for the existing naturally occurring water characteristics (e.g., calcium hardness, chlorides, alkalinity, pH, total dissolved solids, conductivity, etc.) and applied variables (e.g. temperature, evaporation rates, bleed-off rates, etc.), when the makeup water source, in this example, has 1OO ppm calcium ions and 30 ppm chloride ions/300 uS conductivity and the cooling tower water, in this example, contains 900 ppm calcium ions and 150 ppm chloride ions/1500 uS conductivity. The analyzer measures the tower water contains 900 ppm calcium, 150 ppm chloride ions/1500 uS conductivity, then calculates the cooling tower water has 5.00 cycles of concentration, based upon the naturally occurring chloride ion (150 ppm chloride ion tower water/30 ppm chloride ion makeup water=5.00 cycles of concentration) or conductivity (1500 uS conductivity tower water/300 uS conductivity makeup water=5.00 cycles of concentration conductivity).

Understanding 5.00 cycles of concentration exist within the cooling tower water, at the time of this testing, the theoretical minimum concentration of the calcium ion within the cooling tower water is calculated to be 500 ppm (5.00 cycles of concentration33 1OO ppm calcium ions makeup water=500 ppm calcium ions tower water).

Based on the given example, the analyzer has measured and calculated the calcium ion within the cooling tower water as displaying a Hyperactive Behavior (900 ppm calcium ions tower/500 ppm calcium ions theoretical min.=180% of the calcium ions theoretical mill. (Hyperactive Behavior=calcium ions tower greater than 150% of calcium ions theoretical min).

Based upon the PEWTT Analyzer's ability to measure and calculate the behavior of the calcium ion tower water the application of a scale and corrosion inhibitor can be efficiently administered, for constantly changing water characteristics (e.g., chlorides, alkalinity, pH, total dissolved solids, conductivity, etc.) and the applied variables (e.g. temperature, evaporation rates, bleed-off rates, scale and corrosion inhibitor levels, etc.).

1. A Method of Monitoring and Controlling Calcium ion behavior characteristics within a cooling tower system, the process comprising the steps of
collecting a sample of makeup water and cooling tower water, in sequence, of a known volume, at a timed and/or continuous frequency;
performing a titration test for the naturally occurring calcium ion within both the makeup and cooling tower water;
performing a titration test for the naturally occurring chloride ion and/or an electronic measurement of the naturally occurring conductivity within the makeup water and cooling tower water; and
performing a series of calculations to establish a measurement of the calcium ion behavior characteristics within the cooling tower system's water;

2. The process according to claim 1, including responding to the behavior characteristics of the calcium ion within the cooling tower water by increasing or decreasing the chemical treatment dosing; and increasing or decreasing the bleed off rate from the cooling tower system.

3. The method according to claim 1, including collecting a known volume of water sample of the makeup water and cooling tower water, in sequence, at a timed and/or a continuous frequency.

4. The method according to claim 3, including performing a series of liquid titration tests upon the water sample of the makeup water and cooling tower water, in sequence, at a timed and/or continuous frequency, and measuring the calcium ion and the chloride ion concentration within each sample.

5. A Method of Determining Calcium Ion Concentration In A Cooling Tower comprising: determining the naturally occurring calcium ion and chloride/conductivity concentration within said cooling tower's makeup water;
determining the calcium ion and chloride/conductivity within the cooling tower's recirculating water;
calculating the minimum targeted calcium ion within the cooling tower recirculating water based upon the concentration of the naturally occurring calcium ion and chloride/conductivity within the makeup water and recirculating water;
calculating the percentage of calcium ion concentration; and
comparing the percentage of calcium ion concentration to the calculated targeted calcium ion within the cooling tower water, whereby if the actual calcium ion within the cooling tower recirculating water is below the calculated minimum calcium ion, then scaling tendencies have been identified; and if the actual calcium ion within the cooling tower water be 1OO-150% of the calculated minimum calcium ion, then a positive tendency is occurring, and if the actual calcium ion within the cooling tower water is above about 150% of the minimum calcium ion, then calcium ion is being scavenged from the cooling tower system, resulting in a hyperactive tendency.

6. A method according to claim 5 including, based upon monitoring the behavior of the calcium ion within the cooling tower water, carrying out and administering a cooling water scale and corrosion treatment within said cooling tower water to maintain the calcium ion at or slightly above (100-150%) the calculated minimum calcium ion.

7. A method according to claim 5 including maintaining the administration of the cooling water scale and corrosion treatment, based upon the behavior of the calcium ion content, an efficient application of the treatment.

9. The method according to claim 4, including measuring the calcium ion and chloride ion and/or conductivity concentration, and calculating the cycles of concentration according to Formula 1.

10. The method according to claim 9, including calculating the theoretical concentration of the minimum calcium ion within the cooling tower water according to the following Formula 2:
ppm chloride ion tower water/ppm chloride ion makeup water=cycles of concentration chlorides) or conductivity uS conductivity tower water/uS conductivity makeup water=cycles of concentration conductivity).

11. The method according to claim 10, including calculating the theoretical concentration of the minimum calcium ion within the cooling tower water according to Formula 2.

12. The method according to claim 6, comprising measuring and comparing the actual calcium ion concentration within the cooling tower water to the calculated theoretical minimum calcium ion concentration within the cooling tower water based upon the following Formula 3:
ppm calcium ions tower water/ppm calcium ions theoretical min.=% of the calcium ions theoretical min.

13. The method according to claim 7,including determining the behavior of the calcium ion within the cooling tower water, based upon one or more of the following formulae;
Precipitating Behavior=calcium ions tower water less than 100% of calcium ions theoretical min.
Positive Behavior=calcium ions tower water 100%-150% of calcium ions theoretical min.
Hyperactive Behavior=calcium ions tower water greater than 150% of calcium ions theoretical min.

14. The method according to claim 8, including responding to the behavior of the calcium ion as follows;
Precipitating Behavior—Increase/Decrease Chemical Treatment and/or Bleed Off Rate;
Positive Behavior—Increase/Decrease Chemical Treatment and/or Bleed Off Rate; and Hyperactive Behavior—Increase/Decrease Chemical Treatment and/or Bleed Off Rate.

15. The method according to claim 9, including storing and relaying the data and response to a separate computer for observation, display and trending.

16. Apparatus for Monitoring and Controlling Calcium ion behavior within a cooling tower system, comprising:
means for collecting a sample of makeup water and cooling tower water, in sequence, of a known volume, at a timed and/or continuous frequency;
means for performing a titration test for the naturally occurring calcium ion within both the makeup and cooling tower water;
means for performing a titration test for the naturally occurring chloride ion and/or an electronic measurement of the naturally occurring conductivity within the makeup water and cooling tower water; and
means for performing a series of calculations to establish a measurement of the calcium ion behavior characteristics within the cooling tower system's water;

17. The apparatus according to claim 16, including means for responding to the behavior characteristics of the calcium ion within the cooling tower water including means for increasing or decreasing the chemical treatment dosing; and means for increasing or decreasing the bleed off rate from the cooling tower system.

18. The apparatus according to claim 17, including means for collecting a known volume of water sample of the makeup water and cooling tower water, in sequence, at a timed and/or a continuous frequency.

19. The apparatus according to claim 18, including means for performing a series of liquid titration tests upon the water sample of the makeup water and cooling tower water, in sequence, at a timed and/or continuous frequency, and;
means for measuring the calcium ion and the chloride ion concentration within each sample.

20. The apparatus according to claim 17 including means for measuring the electronic conductivity of the makeup water and cooling tower water.
